(19) United States
(12) Patent Application Publication
(10) Pub. No.: US 2025/0170517 A1
(43) Pub. Date: May 29, 2025

(54) DETACHABLE MOLECULAR SIEVE

(71) Applicant: Nanjing Mooxygen Medical Technology Co., Ltd., Nanjing (CN)

(72) Inventor: Ji WU, Nanjing (CN)

(21) Appl. No.: 18/931,225

(22) Filed: Oct. 30, 2024

(30) Foreign Application Priority Data
Nov. 27, 2023 (CN) 202323191584.9

(51) Int. Cl. B01D 53/04; A62B 7/00

(52) U.S. Cl. CPC B01D 53/0407; A62B 7/00; B01D 2253/116; B01D 2256/12; B01D 2257/102

(57) ABSTRACT

A detachable molecular sieve is provided, including an oxygen generator shell and a detachable pull ring. A sieve barrel is inserted into the oxygen generator shell, a sieve barrel cover plate is arranged on the sieve barrel, a pull ring connecting hole is formed on the sieve barrel cover plate, and the pull ring connecting hole is connected with the detachable pull ring.

### CROSS-REFERENCE TO RELATED APPLICATIONS

This application claims priority to Chinese Patent Application No. 202323191584.9, filed on Nov. 27, 2023, the contents of which are hereby incorporated by reference.

### TECHNICAL FIELD

The present disclosure belongs to the technical field of oxygen generators, and in particular relates to a detachable molecular sieve.

### BACKGROUND

With the development of science and technology, people have higher and higher requirements for their own living standards, and various air purifiers and oxygen-increasing devices have gradually entered people's daily lives. Existing oxygen-increasing devices generally use physical pressure swing adsorption method, with molecular sieve as the adsorption carrier, directly compressing air at room temperature and then alternately distributing air into the molecular sieve, and separating nitrogen and oxygen through the process of pressurization and depressurization.

At present, most molecular sieves of household oxygen generators in the market are fixedly installed inside the oxygen generators. After the molecular sieve is installed, the molecular sieve is compactly connected to the oxygen generator. When there is a need to replace the molecular sieve, the sieve barrel is taken out by lifting the steel wire handle. The ordinary steel wire handle in the market is not firm, so it is troublesome to take out the molecular sieve barrel conveniently.

### SUMMARY

An objective of the present disclosure is to provide a detachable molecular sieve to solve the problems raised in the prior art.

In order to achieve the above objective, the present disclosure provides a following solution: a detachable molecular sieve, including an oxygen generator shell and a detachable pull ring. A sieve barrel is inserted into the oxygen generator shell, a sieve barrel cover plate is arranged on the sieve barrel, a pull ring connecting hole is formed on the sieve barrel cover plate, and the pull ring connecting hole is configured for connecting to the pull ring.

In some embodiments, the pull ring includes a circular ring, and the circular ring is provided with a connecting part for connecting the pull ring connecting hole.

In some embodiments, the pull ring connecting hole is provided with threads, the connecting part of the pull ring is set as a threaded section, and the threaded section is in threaded connection with the pull ring connecting hole.

In some embodiments, one side of the sieve barrel cover plate is provided with a protrusion, a through hole is formed on the protrusion, a fastening screw passes through the through hole, and the fastening screw is connected to the oxygen generator shell.

In some embodiments, an adaptation groove is arranged on the oxygen generator shell and at a lower side of the protrusion, and the protrusion is arranged in the adaptation groove.

The technical effect and advantages of the present disclosure are that the detachable molecular sieve is firmer and more reliable than the ordinary steel wire handle on the market, convenient for operation, and has a better lifting feel than the steel wire handle.

### BRIEF DESCRIPTION OF THE DRAWINGS

FIG. 1 is a structural schematic diagram of a detachable molecular sieve of the present disclosure.

FIG. 2 is an exploded view of the detachable molecular sieve of the present disclosure.

### DETAILED DESCRIPTION OF THE EMBODIMENTS

The specific embodiment of the present disclosure will be further explained with the attached drawings. It should be noted here that the description of these embodiments is used to help understand the present disclosure, but it does not constitute the limitation of the present disclosure. In addition, the technical features involved in various embodiments of the present disclosure described below may be combined with each other as long as they do not conflict with each other.

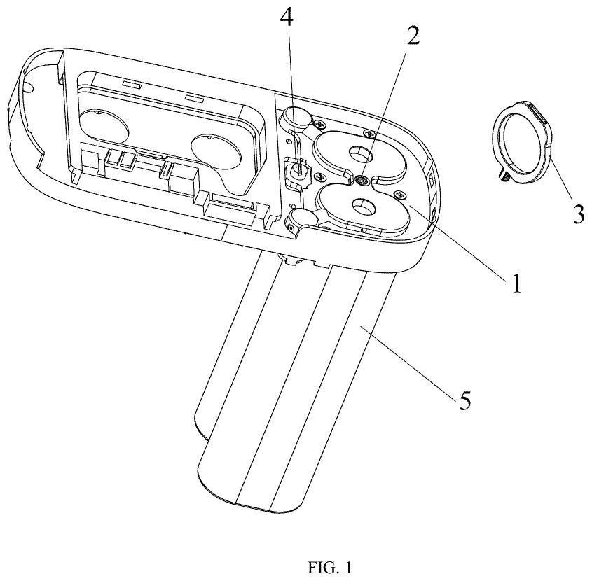

The present disclosure provides a detachable molecular sieve as shown in FIG. 1. The detachable molecular sieve includes an oxygen generator shell 6 and a pull ring 3. A sieve barrel 5 is inserted into the oxygen generator shell 6, a sieve barrel cover plate 1 is arranged on the sieve barrel, a pull ring connecting hole 2 with internal threads is arranged in the middle of the sieve barrel cover plate 1. The pull ring 3 includes a circular ring 7, and the outer surface of the circular ring is provided with a threaded section 8 configured for connecting the pull ring connecting hole, and the threaded section is in threaded connection with the pull ring connecting hole 2, and the circular ring part is lifted to take and put the sieve barrel.

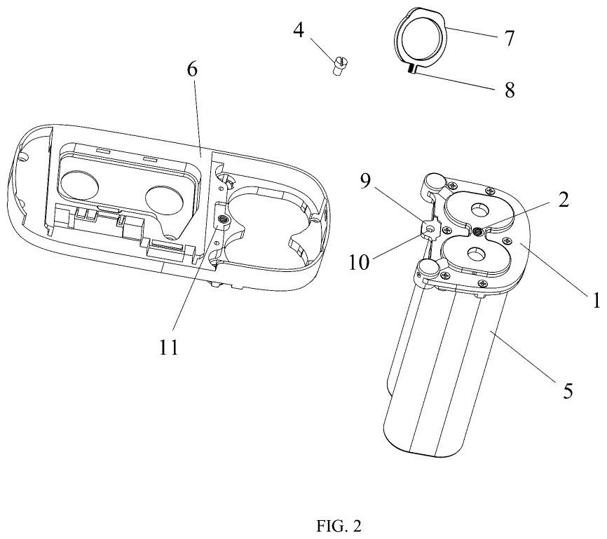

One side of the sieve barrel cover plate 1 is provided with a protrusion 9, and a through hole 10 is formed on the protrusion, and a fastening screw 4 passes through the through hole 10 and is screwed on the oxygen generator shell, so that the sieve barrel 5 is fixed to the oxygen generator shell 1 via the fastening screw. It is convenient to fix the sieve barrel via the fastening screw 4. As shown in FIG. 2, an adaptation groove 11 is arranged on the oxygen generator shell and at a lower side of the protrusion, and the protrusion is arranged in the adaptation groove. After the fastening screw 4 is installed, the protrusion is located in the adaptation groove, so that the fastening screw 4 protrudes less, which is beneficial to the overall compact structural design.

The sieve barrel cover plate 1 is embedded with the pull ring connecting hole 2. The pull ring 3 of the sieve barrel is distributed with the whole machine. The sieve barrel is locked onto the machine shell via the fastening screw 4. When the user replaces the sieve barrel, the fastening screw 4 is removed first, and then the pull ring 3 of the sieve barrel is screwed into the pull ring connecting hole 2 of the sieve barrel cover plate 1, and then the sieve barrel 5 is pulled out, and the pull ring 3 is screwed out after use.

Although the embodiments of the present disclosure have been shown and described above, it may be understood that the above-mentioned embodiments are exemplary and may not be understood as limitations of the present disclosure, and those skilled in the art may make changes, modifications, substitutions and variants to the above-mentioned embodiments within the scope of the present disclosure.

What is claimed is:

1. A detachable molecular sieve, comprising:
an oxygen generator shell, and
a detachable pull ring,
wherein a sieve barrel is inserted into the oxygen generator shell, a sieve barrel cover plate is arranged on the sieve barrel, a pull ring connecting hole is formed on the sieve barrel cover plate, and the pull ring connecting hole is configured for connecting to the pull ring.

2. The detachable molecular sieve according to claim 1, wherein the pull ring comprises a circular ring, and the circular ring is provided with a connecting part for connecting the pull ring connecting hole.

3. The detachable molecular sieve according to claim 2, wherein the pull ring connecting hole is provided with threads, the connecting part of the pull ring is set as a threaded section, and the threaded section is in threaded connection with the pull ring connecting hole.

4. The detachable molecular sieve according to claim 1, wherein one side of the sieve barrel cover plate is provided with a protrusion, a through hole is formed on the protrusion, a fastening screw passes through the through hole, and the fastening screw is connected to the oxygen generator shell.

5. The detachable molecular sieve according to claim 4, wherein an adaptation groove is arranged on the oxygen generator shell and at a lower side of the protrusion, and the protrusion is arranged in the adaptation groove.
